(19) United States
(12) Patent Application Publication
(10) Pub. No.: US 2026/0040112 A1
(43) Pub. Date: Feb. 5, 2026

(54) METHOD AND APPARATUS FOR ENHANCED AUTOMATIC NEIGHBOR REPORTING

(71) Applicant: AT&T Intellectual Property I, L.P., Atlanta, GA (US)

(72) Inventors: Shah Mohammad Murshedul Arefin, Cedar Park, TX (US); Yupeng Jia, South Pasadena, CA (US); Nicholas Thompson, Lake In The Hills, IL (US)

(73) Assignee: AT&T Intellectual Property I, L.P., Atlanta, GA (US)

(21) Appl. No.: 18/793,003

(22) Filed: Aug. 2, 2024

(51) Int. Cl. H04W 24/10; H04W 48/08

(52) U.S. Cl. CPC H04W 24/10; H04W 48/08

(57) ABSTRACT

Aspects of the subject disclosure may include, for example, transmitting, by a processing system including a processor, a measurement configuration message to a mobile communication device that identifies a first subset of frequencies of a group of frequencies in a shared spectrum for wireless communications, where the transmitting the measurement configuration message causes the mobile communication device to perform scanning of the first subset of frequencies without scanning a remainder of frequencies of the group of frequencies; receiving, by the processing system, measurement information from the mobile communication device based on the scanning; and updating, by the processing system, a neighbor relation table based on the measurement information. Other embodiments are disclosed.

### FIELD OF THE DISCLOSURE

The subject disclosure relates to a method and apparatus for enhanced automatic neighbor reporting.

### BACKGROUND

In a cellular network (e.g., 5G and LTE), an end user device (UE) can be instructed by a network to measure candidate frequency of neighbor cells for cell reselection and handover. 3GPP-based systems are generally limited to measuring a fixed amount (e.g., 16 or another number) of inter-frequencies for cell selection or handover. There can be numerous inter-frequencies within the CBRS bands (e.g., 101) that a particular Service Provider can utilize for communication services. In the CBRS spectrum (referred herein as a shared or unlicensed spectrum), the frequency allocation to any base station utilizing CBRS will be dynamic and will be controlled by a Spectrum Access System (SAS), which is a cloud-based service that manages wireless communications over the CBRS band to prevent interference to higher priority users (i.e., Tier 1 Incumbents (e.g., government agencies or satellite stations); Tier 2 Priority Access (e.g., purchased/bid license by priority users); and Tier 3 General Authorized Access (e.g., registered users)).

A Radio Access Network (RAN) of a Service Provider is typically already using most if not all of the inter-frequency measurements slots for scanning its own licensed spectrum. This creates difficulty in a handover to a base station utilizing CBRS since adding the numerous CBRS Absolute Radio-Frequency Channel Numbers (ARFCNs) to an existing inter-frequency measurement list is impractical or impossible. When a UE needs to measure CBRS bands for a cellular to CBRS handover, the UE will be unable to measure any inter-frequencies for the CBRS band if such scanning is not provisioned via an existing inter-frequency measurement list. In that situation, a handover would not be possible between the Service Provider base station (e.g., Macro BS) and a CBRS RAN. Also, even if there was capacity to add CBRS frequencies in the serving cell's measurement list, the difficulty remains because of the dynamic allocation of the CBRS spectrum. The CBRS frequency allocation to the base station is dynamic and controlled by the SAS server, and it will often change based on CBRS traffic such as a priority user (e.g., naval ship) moving into the coverage area of the CBRS RAN.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for causing a UE to scan for shared or unlicensed spectrum. The scanning can be based on a measurement configuration message or other instruction provided by a serving cell (e.g., a macro base station) to one or more UEs in anticipation of a handover to a neighbor cell, such as a CBRS base station or other base station that can utilize a shared spectrum.

In one or more embodiments, a RAN Automatic Neighbor Relation (ANR) function (e.g., being executed at a base station) can be adjusted or supplemented in order to scan for shared or unlicensed spectrum (e.g., CBRS spectrum) and/or other spectrum that is subject to frequent change of use.

In one embodiment, one or more UEs can scan and obtain measurements for some or all ARFCNs (e.g., “high-probability” ARFCN) for the shared spectrum. As an example, this can be triggered or caused by one or more frequencies of the shared spectrum being in a measurement configuration message or measurement list, or according to other criteria, such as known neighbors utilizing shared spectrum. In one embodiment, a base station can update a neighbor relations table and/or inter-frequency measurement lists for handover and/or cell reselection according to measurements from the scanning.

In one embodiment, a RAN network operator can configure how often and what percentage of UEs that are in a coverage area are to perform the scanning for the ARFCNs.

In one embodiment, due to a potential large number of ARFCNs for a shared spectrum (e.g., CBRS ARFCNs), the ANR function of the base station can sample (e.g. 10 ARFCNs) in each iteration until it completes the full list of ARFCNs. This approach can accommodate the finite number of inter-frequency measurement slots available in the RAN network. Other embodiments are described in the subject disclosure.

In one embodiment, to facilitate better coverage and quality to in-building customers, Service Providers and/or Private Cellular Operators can operate in-building 5G/6G/NG and LTE network in CBRS bands or other shared or unlicensed spectrum. In one or more embodiments, handover procedures can be adjusted or supplemented to account for shared spectrum handovers, particularly where frequency allocation can be frequently or constantly changing and controlled by third party devices (e.g., a SAS server in the case of CBRS). In one embodiment, an enhancement can be provided to the RAN ANR function to scan entire (or a particular portion(s)) of shared or unlicensed bands for handover and/or cell selection.

In one or more embodiments, handover and reselection can be improved and sped up between Macro RAN and Private RAN (e.g., CBRS RAN). In one or more embodiments, the system and methods described herein can manage, reduce or eliminate outdated/incorrect neighbor relations information, which may prevent handover between public networks and private RAN networks (e.g., CBRS).

In one or more embodiments, a list of frequencies to be scanned by a UE(s) can be made up of a first pool of frequencies (which may or may not be CBRS frequencies) or a combination of the first pool of frequencies with licensed-spectrum frequencies of the Service Provider.

In one or more embodiments, an iterative process can be provided where multiple UEs participate in scanning and measuring shared or unlicensed frequencies. This distributed approach can facilitate and ensure that the scanning load is shared among several UEs, preventing any single UE from exceeding a scanning limit and disrupting communications, such as on a licensed frequency.

One or more aspects of the subject disclosure include a device, comprising: a processing system including a processor; and a memory that stores executable instructions that, when executed by the processing system, facilitate performance of operations. The operations can include selecting a first subset of frequencies from a group of frequencies for wireless communications; generating a measurement configuration message that allows a limited number of frequencies to be scanned by a mobile communication device, where the measurement configuration message identifies the first subset of frequencies and identifies static frequencies associated with a service provider; and transmitting the measurement configuration message to the mobile communication device to cause the mobile communication device to perform scanning of the first subset of frequencies and the static frequencies.

One or more aspects of the subject disclosure can be a method including transmitting, by a processing system including a processor, a measurement configuration message to a mobile communication device that identifies a first subset of frequencies of a group of frequencies in a shared spectrum for wireless communications, where the transmitting the measurement configuration message causes the mobile communication device to perform scanning of the first subset of frequencies without scanning a remainder of frequencies of the group of frequencies. The method can include receiving, by the processing system, measurement information from the mobile communication device based on the scanning; and updating, by the processing system, a neighbor relation table based on the measurement information.

One or more aspects of the subject disclosure include a non-transitory machine-readable medium, comprising executable instructions that, when executed by a processing system including a processor of a mobile communication device, facilitate performance of operations. The operations can include receiving, from a base station, a measurement configuration message that identifies a subset of frequencies of a group of frequencies in a shared spectrum for wireless communications; scanning the subset of frequencies to obtain measurement information; transmitting, to the base station, a measurement report including the measurement information based on the scanning; and receiving, from the base station, a handover instruction to a target base station operating at a frequency of the group of frequencies in the shared spectrum.

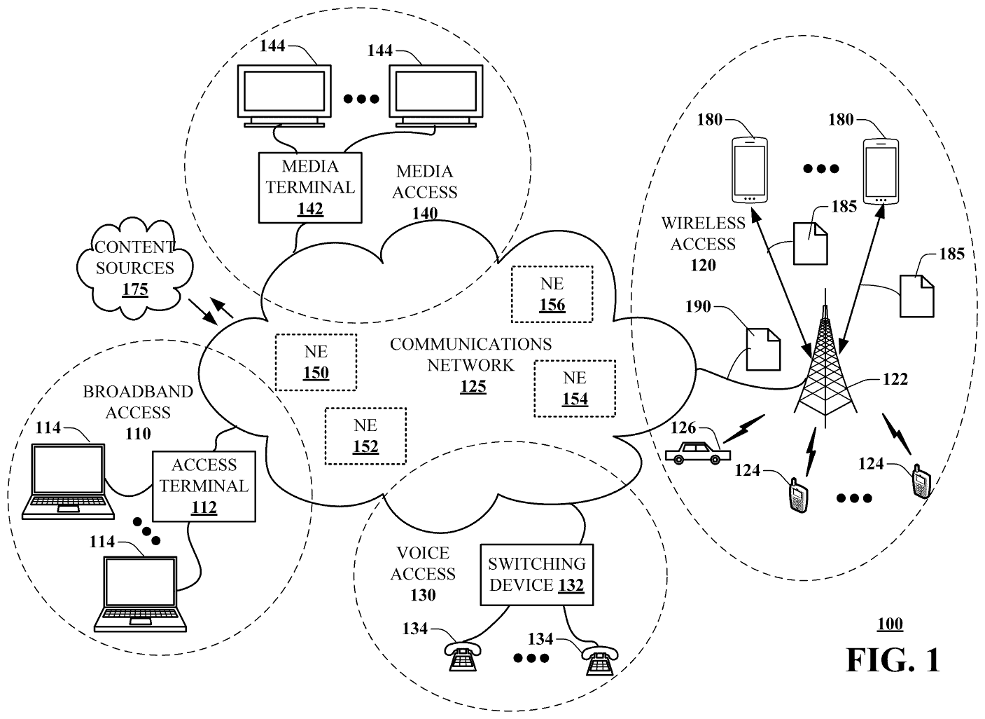

Referring now to FIG. 1, a block diagram is shown illustrating an example, non-limiting embodiment of a system 100 in accordance with various aspects described herein. System 100 can include one or more UEs 180 which can scan for shared or unlicensed spectrum (e.g., CBRS spectrum) in addition to, or instead of, scanning for licensed spectrum. In one embodiment, the scanning can be based on a measurement configuration message 185 or other instruction. In this example, the configuration message 185 can be provided by a serving cell (e.g., a base station 122) to the one or more UEs in anticipation of a handover to a neighbor cell. For instance, the base station 122 can be providing communication services via a licensed spectrum of the Service Provider and can be preparing for a handover to a CBRS base station (not shown) or other base station that can utilize the shared spectrum. In one or more embodiments, a RAN Automatic Neighbor Relation (ANR) function at the base station 122 can be adjusted or supplemented in order to cause the UEs 180 to scan for shared or unlicensed spectrum (e.g., CBRS spectrum) and/or other spectrum that is subject to frequent change of use. System 100 can be implemented with any number of neighbor base stations and neighbor cells for a handover or cell reselection which may be utilizing various shared spectrum (e.g., CBRS).

In one or more embodiments, the scanning for inter-frequencies in the shared spectrum can be a coordinated process utilizing multiple UEs 180 or a coordinated process for a single UE. For example, a RAN network operator can configure how often and what percentage of UEs 180 that are in a coverage area are to perform the scanning for the ARFCNs of the shared spectrum. Additionally, this determination can coordinate scanning just for shared spectrum, scanning just for licensed spectrum, or scanning for a combination of shared and licensed spectrum. For instance, due to a potential large number of ARFCN's for a shared spectrum (e.g., CBRS ARFCNs), the ANR function of the base station 122 can sample ARFCNs in each iteration until it completes the full list of ARFCNs.

In one or more embodiments, the instruction for scanning by the UEs 180 can be triggered or caused by one or more frequencies of the shared spectrum being in a measurement list 190. For example, the measurement list 190 can be generated by the network core of network 125 and/or can be generated by another network element. In one embodiment, the neighbor list 190 can be generated by the base station 122 and provided to the network core and/or to other base station to facilitate scanning of shared spectrum by other UEs via the other base stations. In one embodiment, other criteria can be utilized for generating the neighbor list 190, such as known neighbors utilizing shared spectrum. In one embodiment, the base station 122 can update a neighbor relations table and/or measurement list 190 for handover and/or cell reselection according to measurements from the scanning.

In one or more embodiments, handover procedures performed by the base station 122 and/or the UEs 180 can be adjusted or supplemented to account for shared spectrum handovers, particularly where frequency allocation can be frequently or constantly changing and controlled by third party devices. In one embodiment, an enhancement can be provided to the RAN ANR function of the base station 122 to cause or otherwise coordinate scanning of an entire (or a particular portion(s)) of shared or unlicensed bands for handover and/or cell selection.

In one or more embodiments, system 100 can manage, reduce or eliminate outdated/incorrect neighbor relations information, which may prevent handover between public networks and private RAN networks (e.g., CBRS). In one or more embodiments, a list of frequencies to be scanned by a UE(s) 180 can be made up of a first pool of frequencies (which may or may not be CBRS frequencies) or a combination of the first pool of frequencies with licensed-spectrum frequencies of the Service Provider.

For example, system 100 can facilitate in whole or in part transmitting a measurement configuration message to one or more wireless communication devices that identifies a first subset of frequencies of a group of frequencies in a shared spectrum for wireless communications, where the transmitting the measurement configuration message causes the wireless communication device to perform scanning of the first subset of frequencies; receiving measurement information from the mobile communication device based on the scanning; and updating a neighbor relation table based on the measurement information.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

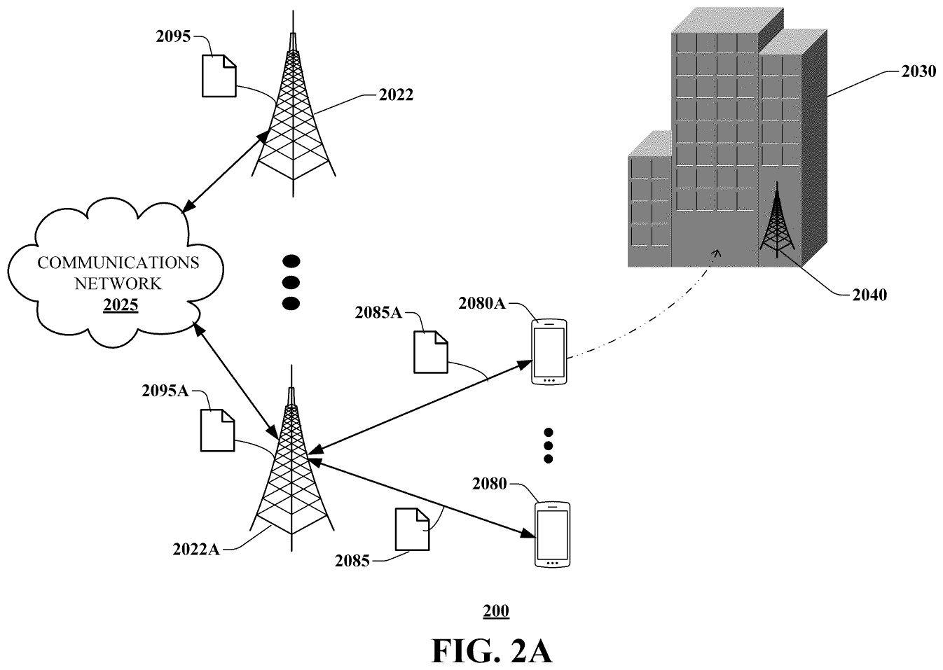

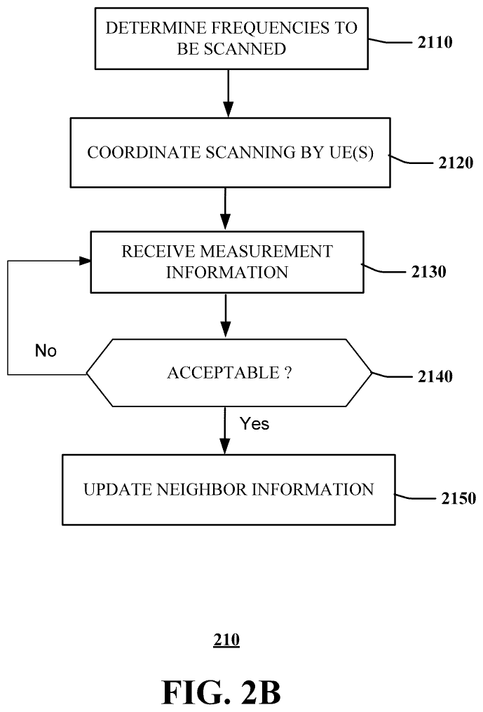

FIG. 2A is a block diagram illustrating an example, non-limiting embodiment of a system 200 functioning within the communication network of FIG. 1 in accordance with various aspects described herein. System 200 can be implemented with any number of neighbor base stations and neighbor cells for a handover and/or cell reselection which may be utilizing various shared spectrum (e.g., CBRS).

System 200 provides for scanning for inter-frequencies in a shared spectrum via a coordinated process. For example, multiple UEs 2080 or a single UE can perform the scanning. In this example, a RAN network operator of communication network 2025 can configure how often and what percentage of UEs 2080 are to perform the scanning, such as for ARFCNs of the shared spectrum (e.g., CBRS). Additionally, the coordination can be scanning just for the shared spectrum, scanning just for licensed spectrum, or scanning for a combination of shared and licensed spectrum. For instance, due to the number of ARFCN's for CBRS, the ANR function of the base station 2022A can sample ARFCNs in each iteration until it completes the full list of ARFCNs (or a desired portion thereof). This can be performed by transmitting the measurement configuration message 2085A to the UE 2080A to trigger the scanning by the UE and the return of measurement information back to the base station 2022A. In other embodiments, the ANR function of the base station 2022A can sample ARFCNs in different UE scannings to complete the full list of ARFCNs. This can be performed by transmitting different measurement configuration messages 2085 to the UEs 2080 to trigger the scanning by each of the UEs and the return of groups of measurement information back to the base station 2022A. In one embodiment, the scanning can include or be supplemented by obtaining various information from the neighbor cell(s), including identification information, System Information Block, and so forth.

In one or more embodiments, the instruction for scanning by the UEs 2080 can be triggered or caused by one or more frequencies of the shared spectrum being in a measurement list 2095. For example, the measurement list 2095 can be generated by the network core of network 2025 and/or can be generated by another network element. In one embodiment, the measurement list 2095A can be generated by the base station 2022A and provided to the network core and/or to other base station(s) 2022 to facilitate scanning of shared spectrum by other UEs via the other base stations. In one embodiment, various criteria and techniques (e.g., including AI/ML) can be utilized for generating the list 2095, such as known neighbors utilizing shared spectrum. In one embodiment, the base station 2022 can update a neighbor relations table and/or measurement list 2095A for handover and/or cell reselection according to measurements from the scanning.

In one embodiment, an enhancement can be provided to the RAN ANR function of the base station 2022A to cause or otherwise coordinate scanning of an entire (or a particular portion(s)) of shared or unlicensed bands for handover and/or cell selection with respect to a building 2030. For example, the building 2030 can include a base station 2040 operating as a small cell, such as a private network. As an example, the base station 2040 may utilize shared spectrum such as CBRS. In one or more embodiments, system 200 can manage, reduce or eliminate outdated/incorrect neighbor relations information, which may prevent handover between public networks and private RAN networks (e.g., CBRS). In one or more embodiments, a list of frequencies to be scanned by a UE(s) 2080A can be made up of a first pool of frequencies (which may or may not be CBRS frequencies) or a combination of the first pool of frequencies with licensed-spectrum frequencies of the Service Provider.

System 200 can include UEs 2080 which can scan for shared or unlicensed spectrum (e.g., CBRS spectrum) in addition to or instead of scanning for licensed spectrum.

In one or more embodiments, the measurement configuration message 2085 can include Measurement Objects which are a description of what the UE should measure (e.g., specific cells, frequency bands, or signal quality indicators); Measurement Quantity which specifies a type(s) of measurement (e.g., RSRP, RSRQ, SNR); Measurement Reporting Configuration which defines reporting criteria (e.g., thresholds, reporting intervals); Measurement Gap Configuration which can be gaps in UE transmission for accurate measurements without disrupting normal communication; and Measurement Events and Triggers which can identify events that trigger measurement based on specific conditions (e.g., handover preparation, interference detection).

System 200 can efficiently provide for handover/reselection scanning where there are many different frequencies, such as within the CBRS band. For example, the CBRS band is 150 megahertz width, but within that band there can be numerous potential frequencies (e.g., 101). In one or more embodiments, the CBRS band can be used in a private network, such as operating via base station 2040. For example, the allocation of the frequency can be dependent on an SAS server (not shown) and depending on whomever (e.g., a government agency) is using a particular CBRS frequency in the geographic area, the frequency allocation may change. In one or more embodiments, a handover and cell selection occurring between the base station 2022A and a CBRS network provided via base station 2040 can be based on a dynamic or changing frequency due to a private network that is using a particular CBRS spectrum.

In one embodiment, multiple inter-frequencies (e.g., sixteen or another number) can be placed in a RAN scheduler to measure frequency from another cell. These inter-frequencies can be all licensed spectrum, all shared/unlicensed spectrum, and/or a combination of licensed and shared/unlicensed spectrum.

System 200 can efficiently coordinate scanning, particularly because Service Providers often operate utilizing a fragmented spectrum and the RAN is already measuring many different frequencies, so there may be a limited number of measurement slots available.

In one or more embodiments, each time a RAN ANR function (e.g., being executed at the base station 2022A) identifies that a frequency in a shared spectrum (e.g., CBRS spectrum) is included in a measurement list (e.g., provisioned to the base station by the network core), then the ANR function can proceed with transmitting measurement configuration message(s) to obtain scanning associated with the corresponding shared spectrum. In one embodiment, this functionality can include obtaining unknow information via the UE, such as a PCI of a neighbor cell utilizing the CBRS spectrum.

In one embodiment, each base station 2022A may store the most recent successful frequency measurements in a shared spectrum and re-scan based on those frequencies (e.g., in a first iteration of scanning by the UE) to provide measurement information from which the base station can adjust a neighbor relations table.

FIG. 2B depicts an illustrative embodiment of a method in accordance with various aspects described herein. Method 210 can include at 2110 determining frequencies that are to be scanned, such as for a handover or cell selection. These frequencies can be from a shared or unlicensed spectrum (e.g., CBRS) or from multiple different shared spectrums if they are available for use in the particular coverage area. The frequencies for scanning can also be supplemented with or otherwise include licensed spectrum of the Service Provider.

In one embodiment, the inclusion of one or more frequencies from a shared spectrum in a measurement list (e.g., generated by the network core, the base station, and/or other network elements) can trigger the frequency determination. For example, a base station can be provisioned (e.g., by the network core and/or at the time of building) with a measurement list that includes licensed spectrum of the Service Provider and one or more shared spectrum frequencies that are typically or previously available for use. If one of those frequencies is in a shared spectrum such as CBRS, then a determination can be made to scan all of the available CBRS frequencies because availability may change due to the dynamic nature of the shared spectrum.

At 2120, a coordination scheme for the scanning can be generated or otherwise implemented. For example, if there were 101 potential inter-frequencies in a shared spectrum then a coordination scheme can be devised to send different measurement configuration messages (which include the inter-frequencies to be scanned) to different UEs to cover the entire range. In other embodiments, the selection of the inter-frequencies to be included in measurement configuration messages can be based on predictive modeling. For instance, AI/ML can be applied to determine a most-likely available frequency and/or a frequency most likely having a satisfactory (e.g., above a threshold) or best characteristics (e.g., signal strength or other RF measurements). Various factors, including historical measurements, knowledge of government agencies predicted use of CBRS frequencies (e.g., a navy ship will be entering the coverage area at a particular time), and so forth, can be utilized for the predictive modeling. As an example, the predictive modeling can be utilized to make the scanning more efficient by prioritizing the order of scanning such as providing the “most likely” as described above at the top of the measurement list.

Other techniques can be utilized for coordinating distribution of the frequencies of the shared spectrum. For example, frequencies in the shared spectrum can be randomly assigned for scanning to different UEs. In another embodiment, frequencies in the shared spectrum can be assigned according to historical assignments for scanning to different UEs (e.g., previously scanned by a particular UE and/or previously at top of list for scanning).

In one or more embodiments, scanning can be coordinated as an iterative process. For example, if there is a single UE to perform the scanning or a small number of UEs, then the frequencies can be scanned iteratively over time by the single UE or the small number of UEs. In this example, finding a frequency for handover and/or cell reselection may take a single iteration (e.g., the shared spectrum frequency is on a first measurement configuration message which may be for a number of different reasons including predictive modeling, previously scanned, random, etc.) or may take several iterations (e.g., the shared spectrum frequency is on a second, third, fourth etc. measurement configuration message).

At 2130, measurement information can be received from one or more UEs, such as by the base station of the serving cell, as a result of the transmitting of the measurement configuration message(s). In one or more embodiments, the scanning capability of a UE can be limited and thus a measurement configuration message can cause a UE to perform scanning of particular frequencies without scanning a remainder of frequencies of the shared spectrum. The type of measurement information can vary and can include signal strength, as well as other information such as Physical Cell Identity (PCI), EUTRA Cell Global Identifier (ECGI), Tracking Area Code (TAC), Public Land Mobile Network (PLMN) list of the target cell, Cell Global Identity (CGI), Location Area Code (LAC) and Routing Area Code (RAC) depending on the Radio Access Technology (RAT) being utilized.

At 2140, a determination can be made according to the received measurement information as to whether the frequency(ies) such as of the shared spectrum and/or the licensed spectrum is acceptable (e.g., according to a threshold(s)) and if so then at 2150 a neighbor relation table of the base station can be adjusted. For example, the adjustment can be to add the neighbor relation, identification information, neighbor relation attributes and/or other information (e.g., the acceptable scanned frequency(ies)) based on the measurement information. As described herein, the measurement information can be of various types including signal strength, Reference Signal Received Power (RSRP), Reference Signal Received Quality (RSRQ), Received Signal Strength Indicator (RSSI), Signal-to-Noise and Interference Ratio (SINR).

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one or more embodiments, the system and methods described herein for scanning frequencies of a shared spectrum can be used in conjunction with or a supplement to ANR functions, including Neighbor Removal Function, Neighbor Detection Function and Neighbor Relation Table Management Function. In one embodiment, the Neighbor Relation Detection procedure can include instructions to an RRC to measure the cells on some certain frequency or in another RAT, where: the RRC forwards the measurement reports to Neighbor Detection Function; the Neighbor Detection Function decides to add a new Neighbor Relation; the Neighbor Relation Table Management Function updates the Neighbor Relation Table; the Neighbor Relation Table Management Function sends the updated Neighbor Relation to OAM; and OAM requests Neighbor Relation Table Management Function to update the Neighbor Relation Attributes.

In one or more embodiments, a network and/or base station(s) can communicate with an SAS server regarding CBRS frequencies to facilitate scanning for available inter-frequencies associated with CBRS coverage.

In one or more embodiments, the methods described herein for scanning for shared spectrum can be performed in a system that includes a Central Unit (CU) (e.g., operating in a cloud) serving multiple Distributed Units (DUs), each of which in turn serves multiple Radio Units (RUs). In one embodiment, an RRC (centralized in the CU) can be responsible for making only near-real-time configuration and control decisions, while a Scheduler that is part of the MAC stage can be responsible for real-time scheduling decisions. In one or more embodiments, the methods described herein for scanning for shared spectrum can be performed in a system that includes RU-DU connectivity (i.e., Fronthaul); DU-CU connectivity (i.e., Midhaul); and CU-Mobile Core connectivity (i.e., Backhaul).

In one or more embodiments, the methods described herein for scanning for shared spectrum can be performed in a system in conjunction with other functions, procedures and/or components including an eNodeB for LTE or gNodeB for 5G NR or next generation network sending a measurement configuration message to the UE, specifying which frequencies (which can include one or more shared spectrum frequencies) to measure; the UE performing inter-frequency measurements by temporarily stopping communicating with the serving cell and tuning the UE receiver to the specified frequencies during measurement gaps, which can be predefined intervals where the UE is allowed to perform the measurements; and the UE measuring signal strength and/or quality of specified frequencies and reporting these measurements back to the base station so that the base station can use this information to make handover decisions (which can include determining to handover to a private network utilizing a shared spectrum such as CBRS).

In one or more embodiments, the methods described herein for scanning for shared spectrum can be performed in a system in conjunction with other functions, procedures and/or components including the measurement configuration message sent by the base station specifying measurement objects, reporting criteria, and other relevant parameters; the UE scanning and measuring the specified frequencies, which can include signal strength (e.g., RSRP) and signal quality (e.g., RSRQ) of detected cells (which can include cells being provided coverage via a private network such as through use of CBRS) on the specified frequencies; the base station, according to the measurement reports received from the UE, making handover decisions by evaluating the reported measurements to determine the best target cell for handover, which can be based on factors such as signal strength, signal quality, and network conditions; and if the base station decides that a handover is necessary, sending from the base station a handover command to the UE, specifying the target cell and frequency so that the UE then executes the handover to the specified target cell (which can include a private network utilizing a shared spectrum such as CBRS).

In one or more embodiments, the methods described herein for scanning for shared spectrum can be performed in a system in conjunction with other functions, procedures and/or components including accommodating a scenario when a UE tries to handover to a CBRS frequency that is no longer in use: the UE attempts to connect to the target cell on the specified CBRS frequency but since the frequency is no longer in use the UE will fail to establish a connection with the target cell and this failure is detected by the UE based on the absence of expected signals or responses from the target cell; the UE, upon detecting the handover failure, initiating a fallback mechanism that can involve reverting to the original serving cell or attempting to connect to an alternative cell so that the UE maintains connectivity and service continuity even if the handover to the target cell fails; the UE reporting the handover failure to the base station where the report includes information about the failed handover attempt, such as the target cell and frequency, and the reason for the failure (e.g., frequency no longer in use); the base station, upon receiving the handover failure report, reevaluating the handover decision, which can include update a neighbor relations and measurement configuration based on the new information and/or instructing the UE to perform new measurements on alternative frequencies to identify a suitable target cell for handover; and the base station, based on the updated measurements and reevaluation, attempting to initiate a new handover to a different target cell and frequency whereby the UE follows the new handover instructions and attempts to connect to the newly specified target cell.

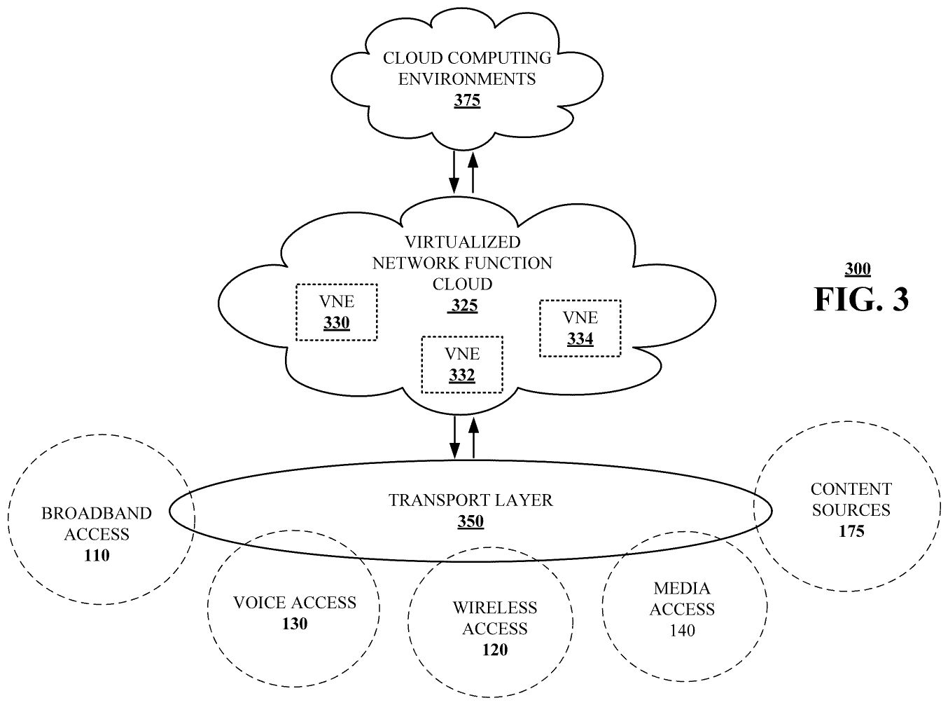

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, and 3. For example, virtualized communication network 300 can facilitate in whole or in part transmitting a measurement configuration message to one or more wireless communication devices that identifies a first subset of frequencies of a group of frequencies in a shared spectrum for wireless communications, where the transmitting the measurement configuration message causes the wireless communication device to perform scanning of the first subset of frequencies; receiving measurement information from the mobile communication device based on the scanning; and updating a neighbor relation table based on the measurement information.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

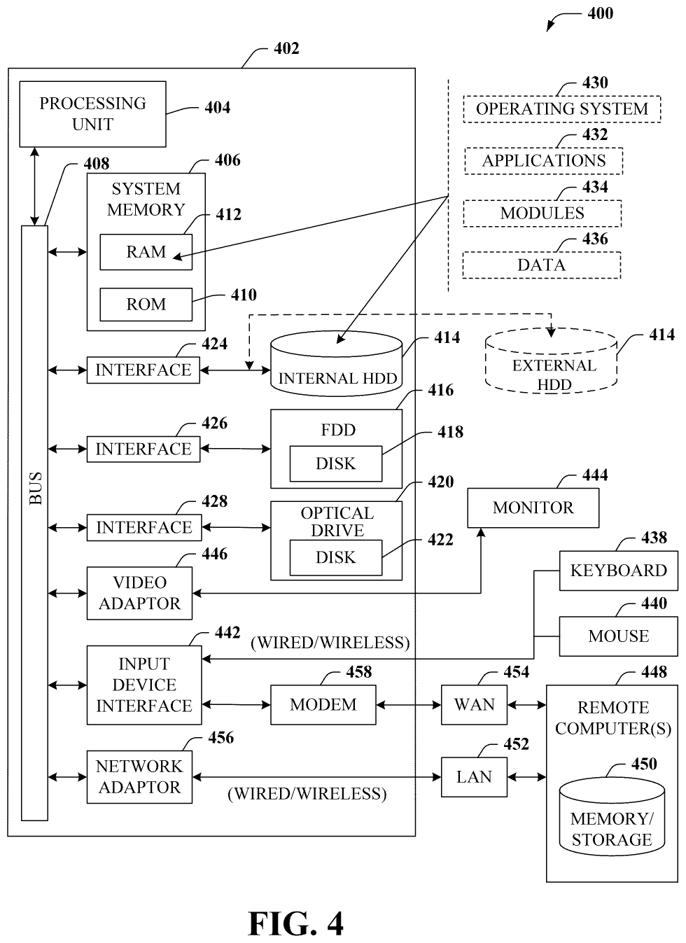

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part transmitting a measurement configuration message to one or more wireless communication devices that identifies a first subset of frequencies of a group of frequencies in a shared spectrum for wireless communications, where the transmitting the measurement configuration message causes the wireless communication device to perform scanning of the first subset of frequencies; receiving measurement information from the mobile communication device based on the scanning; and updating a neighbor relation table based on the measurement information.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Other processing components and techniques can also be implemented, including multi-core processors and storage (e.g., NVRAM storage).

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices. The computer 402 can operate communicating over any network, including 4G, 5G, next generation, and so forth networks and utilizing various Radio Access Technologies. In one embodiment, the computer 402 can communicate via a Software-Defined Wide-Area Network (SD-WAN) where the SD-WAN intelligently routes traffic based on particular requirements for a service by routing traffic and enforcing Service Level Agreements (SLAs) differently for each service including based on priority, security requirements, application, and user group. This can be done through a control plane to centrally manage Quality of Service (QOS), security policies, and routing options across the network.

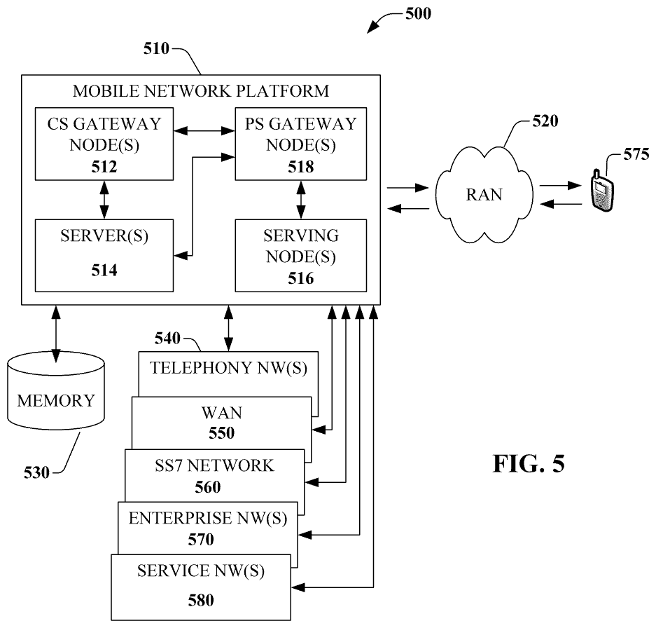

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part transmitting a measurement configuration message to one or more wireless communication devices that identifies a first subset of frequencies of a group of frequencies in a shared spectrum for wireless communications, where the transmitting the measurement configuration message causes the wireless communication device to perform scanning of the first subset of frequencies; receiving measurement information from the mobile communication device based on the scanning; and updating a neighbor relation table based on the measurement information.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology (ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

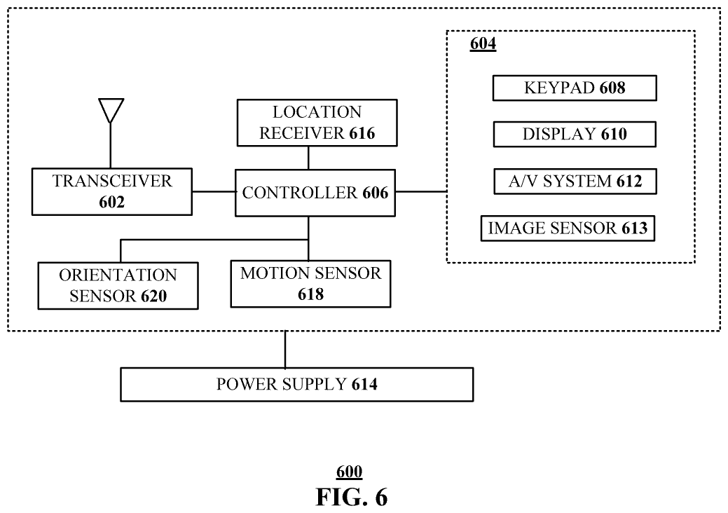

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part transmitting a measurement configuration message to one or more wireless communication devices that identifies a first subset of frequencies of a group of frequencies in a shared spectrum for wireless communications, where the transmitting the measurement configuration message causes the wireless communication device to perform scanning of the first subset of frequencies; receiving measurement information from the mobile communication device based on the scanning; and updating a neighbor relation table based on the measurement information.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
selecting a first subset of frequencies from a group of frequencies for wireless communications;
generating a measurement configuration message that allows a limited number of frequencies to be scanned by a mobile communication device, wherein the measurement configuration message identifies the first subset of frequencies and identifies static frequencies associated with a service provider; and
transmitting the measurement configuration message to the mobile communication device to cause the mobile communication device to perform scanning of the first subset of frequencies and the static frequencies.

2. The device of claim 1, wherein the group of frequencies are in citizens broadband radio service spectrum.

3. The device of claim 1, wherein the selecting the first subset of frequencies is based on predictive modeling.

4. The device of claim 1, wherein the operations further comprise:
selecting a second subset of frequencies from a group of frequencies for wireless communications, wherein at least one frequency of the second subset of frequencies is different from the first subset of frequencies;
generating a subsequent measurement configuration message that allows a limited number of frequencies to be scanned by the mobile communication device, wherein the subsequent measurement configuration message identifies the second subset of frequencies and identifies the static frequencies associated with the service provider; and
transmitting the subsequent measurement configuration message to the mobile communication device to cause the mobile communication device to scan the second subset of frequencies and the static frequencies.

5. The device of claim 1, wherein the operations further comprise receiving measurement information from the mobile communication device based on the scanning of the first subset of frequencies and the static frequencies.

6. The device of claim 5, wherein the operations further comprise updating a neighbor relation table based on the measurement information.

7. The device of claim 1, wherein the operations further comprise:
selecting a second subset of frequencies from a group of frequencies for wireless communications, wherein at least one frequency of the second subset of frequencies is different from the first subset of frequencies;
generating a subsequent measurement configuration message that allows a limited number of frequencies to be scanned by a second mobile communication device, wherein the subsequent measurement configuration message identifies the second subset of frequencies and identifies the static frequencies associated with the service provider; and
transmitting the subsequent measurement configuration message to the second mobile communication device to cause the second mobile communication device to scan the second subset of frequencies and the static frequencies.

8. The device of claim 1, wherein the selecting of the first and second subsets of frequencies is based on predictive modeling performed by a network device.

9. A method, comprising:
transmitting, by a processing system including a processor, a measurement configuration message to a mobile communication device that identifies a first subset of frequencies of a group of frequencies in a shared spectrum for wireless communications, wherein the transmitting the measurement configuration message causes the mobile communication device to perform scanning of the first subset of frequencies without scanning a remainder of frequencies of the group of frequencies;
receiving, by the processing system, measurement information from the mobile communication device based on the scanning; and
updating, by the processing system, a neighbor relation table based on the measurement information.

10. The method of claim 9, comprising transmitting, by the processing system, a handover instruction to the mobile communication device causing a handover of the wireless communications from the processing system to a base station operating at a frequency of the first subset of frequencies of the group of frequencies in the shared spectrum.

11. The method of claim 9, wherein the shared spectrum includes citizens broadband radio service spectrum, and wherein the measurement configuration message identifies frequencies in a licensed spectrum of a service provider.

12. The method of claim 9, wherein the first subset of frequencies is selected from the group of frequencies based on predictive modeling.

13. The method of claim 9, comprising:
selecting, by the processing system, multiple subsets of frequencies from the group of frequencies in the shared spectrum for the wireless communications, wherein the multiple subsets of frequencies include the first subset of frequencies and a second subset of frequencies, wherein the second subset of frequencies is different from the first subset of frequencies;
generating, by the processing system, a second measurement configuration message that identifies the second subset of frequencies;
transmitting, by the processing system, the second measurement configuration message to a second mobile communication device that causes the second mobile communication device to perform scanning of the second subset of frequencies without scanning a remainder of frequencies of the group of frequencies;
receiving, by the processing system, second measurement information from the second mobile communication device based on the scanning; and
updating, by the processing system, the neighbor relation table based on the second measurement information.

14. The method of claim 13, wherein the selecting of the first and second subsets of frequencies is based on predictive modeling.

15. A non-transitory machine-readable medium, comprising executable instructions that, when executed by a processing system including a processor of a mobile communication device, facilitate performance of operations, the operations comprising:
receiving, from a base station, a measurement configuration message that identifies a subset of frequencies of a group of frequencies in a shared spectrum for wireless communications;
scanning the subset of frequencies to obtain measurement information;
transmitting, to the base station, a measurement report including the measurement information based on the scanning; and
receiving, from the base station, a handover instruction to a target base station operating at a frequency of the group of frequencies in the shared spectrum.

16. The non-transitory machine-readable medium of claim 15, wherein the shared spectrum includes citizens broadband radio service spectrum, and wherein the measurement configuration message identifies frequencies in a licensed spectrum of a service provider.

17. The non-transitory machine-readable medium of claim 15, wherein a neighbor relation table is updated based on the measurement information.

18. The non-transitory machine-readable medium of claim 15, wherein the subset of frequencies of the group of frequencies in the shared spectrum is selected based on predictive modeling.

19. The non-transitory machine-readable medium of claim 18, wherein the predictive modeling is performed by a network server.

20. The non-transitory machine-readable medium of claim 15, wherein the subset of frequencies is one of multiple subsets of frequencies selected by the base station from the group of frequencies in the shared spectrum for the wireless communications, wherein the multiple subsets of frequencies include a second subset of frequencies, wherein the second subset of frequencies is different from the subset of frequencies, and wherein a second measurement configuration message identifying the second subset of frequencies is transmitted by the base station to a second mobile communication device.
